(19) United States
(12) Patent Application Publication
(10) Pub. No.: US 2006/0233089 A1
(43) Pub. Date: Oct. 19, 2006

(54) Optical recording medium

(75) Inventors: Noriko Inoue, Odawara (JP); Hiroaki Takano, Odawara (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/399,511

(22) Filed: Apr. 7, 2006

(30) Foreign Application Priority Data
Apr. 13, 2005 (JP) 2005-115979

(51) Int. Cl. G11B 7/135; G11B 7/00

(52) U.S. Cl. 369/112.01

(57) ABSTRACT

A three-dimensional optical recording medium including an optical information recording layer held and sandwiched between the light transmissive substrates has a recording region for recording a positioning signal to determine a recording location of the optical information only at a periphery of the optical recording medium.

### BACKGROUND OF THE INVENTION

### Field of the Invention

The present invention relates to an optical recording medium, particularly, to the optical recording medium for a three-dimensional recording such as a hologram memory, a multilayer optical memory and a memory using near field light.

As a method of recording for a three-dimensional recording medium, are known a rotational recording method for multiple-recording optical information in a rotated disk medium and a stop and go method in which, after recording, a multiple recording position is changed stepwise without rotating an optical recording medium during recording. As the three-dimensional recording medium using the rotational recording method, is known a three-dimensional recording medium having pits for servo control of irradiation positions of recording light and reference light upon recording and reproducing of optical information. For example, Japanese laid-open patent application publication No. 2002-63733 discloses such a method at paragraphs from 0013 to 0018, and FIG. 2. This three-dimensional recording medium has a recording layer on a transparent substrate where a plurality of pits are formed on a surface of the transparent substrate along each of defined coaxial circular tracks. In this three-dimensional recording medium according to the rotational recording method, the recording light and the like are subject to the servo control depending on that the pit is detected with servo light radiated from the transparent substrate side. On the other hand, the recording light and the like, radiated from the transparent substrate side, are recorded in the recording layer to record optical information.

### SUMMARY OF THE INVENTION

An aspect of the present invention provides a three-dimensional optical recording medium comprising: first and second light transmissive substrates; an optical information recording layer held and sandwiched between the first and second light transmissive substrates for recording optical information; and a recording region only at a periphery of the optical recording medium, the recording region recording a positioning signal to determine a recording location of the optical information.

This three-dimensional optical recording medium can provide a recording medium with a high recording capacity because a recording area of the optical information can be secured at an area other than a periphery of the optical recording medium. In this three-dimensional optical recording medium, preferably, the recording region of the optical information and the recording region of the positional signal are separately provided. This prevents the recording light and the reference light from being scattered. As a result, the optical information can be accurately recorded and reproduced in this three-dimensional optical recording medium.

Further, in such a three-dimensional optical recording medium, preferably, the positioning signal is recorded by a local change in a physical property of a medium forming material which is optically detectable. Here, the medium forming material may be of one or more type of material forming the three-dimensional optical recording medium. The physical property change of the medium forming material is not limited if it is optically detectable. For example, it may be a protrusion, a pit (depression), a hole, a ridge, a channel, a ridge and channel pattern, and an air gap (air bubble) and the like in the medium forming material.

Further, preferably, the physical property change includes an optical diffraction change, an optical transmittance change, a reflectance change regarding illumination light, and a wavelength change regarding the illumination light. Further, preferably, the physical property change is provided at a surface of or inside the three-dimensional optical recording medium in an optically detectable manner.

Further, the physical property change may be provided on a side face regarding a thickness direction of the three-dimensional optical recording medium. For example, the physical property change may be provided by ridges and channels alternately, periodically formed at a predetermined pitch.

Further, in the three-dimensional optical recording medium including a recording material sandwiched between upper and lower substrates, the positioning signal may be formed both at the upper and lower substrates. The positioning signal is, preferably, recorded by an optically detectable local change in the physical property of the optical recording medium, wherein a type of the change recorded in the first light transmissive substrate is the same as or different from a type of the change recorded in the second light transmissive substrate.

In addition, in such a three-dimensional optical recording medium, preferably, the physical property changes periodically at an interval not less than 0.5 μm and not greater than 100 μm. In addition, preferably, the three-dimensional optical recording medium is formed in a disk. In this case, the positioning signal is recorded at a periphery of the disk. Further, if the three-dimensional optical recording medium has a center hole, the positioning signal may be recorded around the center hole. In such a three-dimensional optical recording medium, preferably, the optical information is recorded by a method selected from the group of a shift multiplexing method, an angular multiplexing method, a wavelength multiplexing method, a phase code multiplexing method, and a Polytopic multiplexing method or a combination method including these methods in the group.

In such a three-dimensional optical recording medium, preferably, the optical information is recorded by a stop and go method.

### BRIEF DESCRIPTION OF THE DRAWINGS

The object and features of the present invention will become more readily apparent from the following detailed description taken in conjunction with the accompanying drawings in which:

FIG. 1A is a perspective view of a three-dimensional optical recording medium according to an embodiment of the present invention;

FIG. 1B is an enlarged view of an λ part shown in FIG. 1A;

FIGS. 2A and 2B are schematic views illustrating processes of recording optical information in the three-dimensional recording medium;

FIG. 3 is a partial perspective view of a three-dimensional optical recording medium according to a modification of the present invention;

FIG. 4 is a side cross-sectional view of a three-dimensional optical recording medium according to a further modification of the present invention;

FIG. 5 is a schematic view of a diffraction efficiency measuring apparatus used in the embodiment;

FIGS. 6 and 7 are perspective views of still further modifications of the optical recording medium according to the present invention;

FIG. 8 is a partial perspective view of another modification of the optical recording medium according to the present invention; and

FIG. 9 is a sectional view of a further modification of the optical recording medium according to the present invention.

The same or corresponding elements or parts are designated with like references throughout the drawings.

### DETAILED DESCRIPTION OF THE INVENTION

Prior to describing an embodiment of the present invention, the prior art disclosed in Japanese laid-open patent application publication No. 2002-63733 mentioned above will be argued.

In this conventional three-dimensional optical recording medium, when transmitted through the transparent substrate, the recording light is scattered in the recording layer because the recording light and other light hit the pit.

As a result, the optical information may be incorrectly recorded. In addition, if it is assumed that the optical information cannot be recorded at areas of the pits and the vicinity of the pits, a recording capacity largely decrease.

On the other hand, in the stop and go method, there is no method of determining the irradiation position of the recording light on the three-dimensional optical recording medium during recording and reproducing the optical information. However, although the optical information is recoded and reproduced by the stop and go method, to accurately record the optical information in the three dimensional optically recording medium with a larger capacity and accurately reproduce the recorded optical information, the radiated recording light and the like should be accurately positioned.

The present invention provides a three-dimensional optical recording medium capable of having a large capacity of the optical information as well as accurately recording and reproducing the optical information.

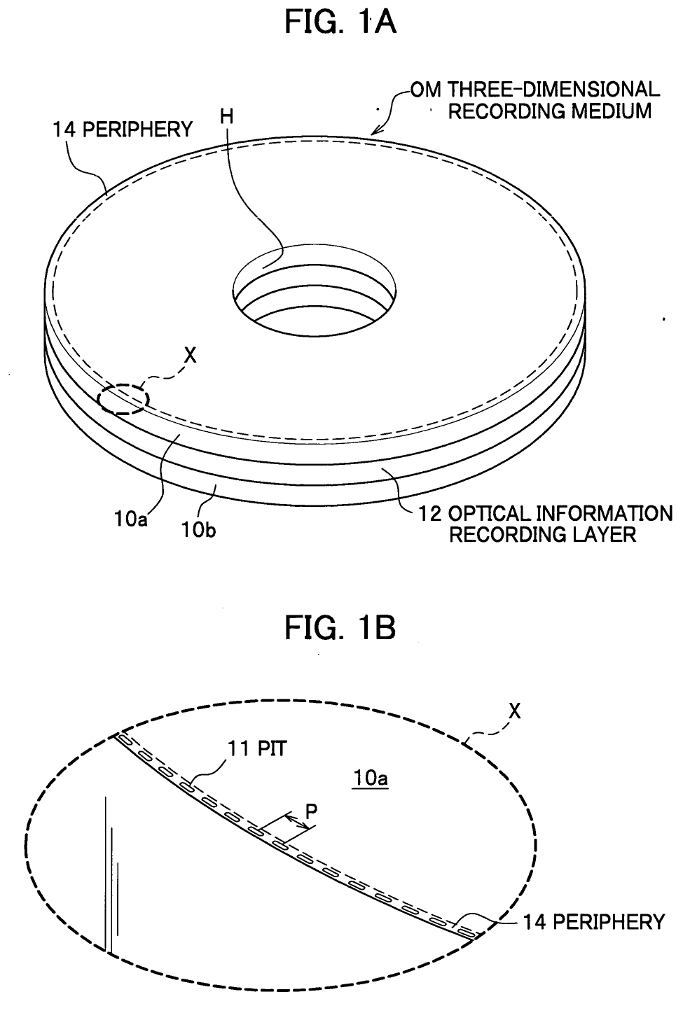

Hereinafter will be described an embodiment of the present invention in details with reference to drawings. FIG. 1A is a perspective view of a three-dimensional optical recording medium of the embodiment, and FIG. 1B is a schematic enlarged view illustrating an X part in FIG. 1A. In this embodiment, will be described a three-dimensional optical recording medium for recording the optical information using hologram (interference) as an example.

As shown in FIG. 1A, a three-dimensional optical recording medium OM (hereinafter, simply referred to as “optical recording medium OM”) is a disk having a center hole H formed for fitting this optical recording medium OM to a driving shaft of a recording and reproducing apparatus (not shown). The optical recording medium OM includes a first light transmissive substrate 10a and a second light transmissive substrate 10b, and an optical information recording layer 12.

The light transmissive substrates 10a and 10b are disk members having center holes corresponding to the center hole H and are arranged to hold and sandwich an optical information recording layer 12. The light transmissive substrates 10a and 10b have thicknesses ranging from 0.05 to 1.2 mm, respectively.

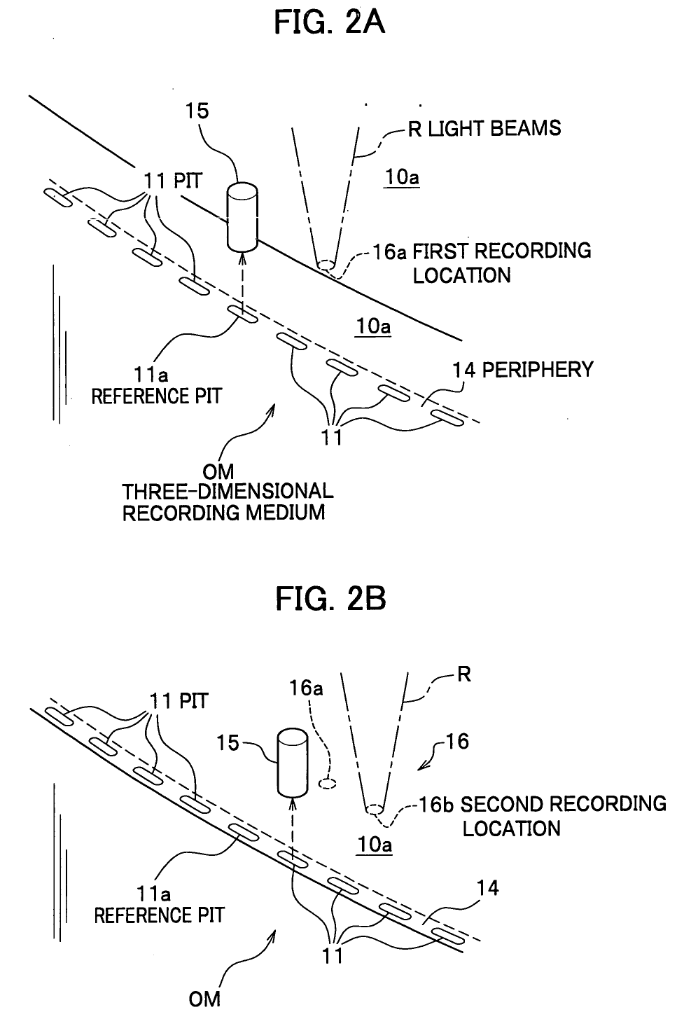

As shown in FIG. 1B, provided at a periphery 14 of the first light transmissive substrate 10a is a recording region of a positioning signal for determining a recording location of the optical information. The positioning signal is recorded as pits 11 defined as a local change in a medium forming material, namely, a change in a local shape of the material of the first light transmissive substrate 10a after shaping (not raw material), as compared with its vicinity. As shown in FIG. 1B, the pits 11 are minute depressions formed equidistantly arranged along a circumference of the first light transmissive substrate 10a, the pitch P of which is equal to or greater than 0.5 μm and equal to and smaller than 100 μm. The pits 11 have a lower reflectance than that at any location other than the pits 11, thus providing detection thereof by an optical sensor 15 (see FIG. 2A, mentioned later) for receiving the reflected light. The pit 11 is not limited in shape, but has, in this embodiment, an ellipse hole having a length of 0.4 μm to 3 μm and a width of about 0.4 μm. A depth of the pit 11 varies depending on a material of the light transmissive substrate 10a in use, wherein the depth is adaptively determined to detect a difference in the reflectance of light between the pit 11 and any part other than the pit 11 (vicinity of the pit 11).

These light transmissive substrates 10a and 10b are composed of for example, an inorganic substance such as glass and synthetic resins such as a polycarbonate, triacetylcellulose, cycloolefin polymer, polyethylene terephthalate, polyphenylene sulfide, acrylic resin, methacrylic resin, polystyrene resin, vinyl chloride resin, epoxy resin, polyester resin, and amorphous polyolefin. Specifically, glass, polycarbonate, and triacetylcellulose are preferable because of a lower double refractivity. The light transmissive substrates 10a and 10b may be formed of a same material, or of different materials. At surfaces of the light transmissive substrates 10a and 10b may be provided an antireflection coating, an oxygen anti-permeable coating, a moisture anti-permeable coating, a UV cut coating, and the like as needed.

The optical information recording layer 12 is a disk member having a hole, at the middle thereof, corresponding to the center hole H and disposed between the light transmissive substrates 10a and 10b. The optical information recording layer 12 is a layer for recording the optical information by being irradiated with light and formed of an optical reactive resin composition having a thickness of 0.5 to 2.5 mm and preferably, of 0.5 to 2.0 mm. As the optical reactive resin, a photopolymer material can be used. The photopolymer material contains a polymeric monomer, a sensitizing dye, a polymerization initiator, and a binder.

A polymeric monomer is not specifically limited if it has a polymerization group. For example, a radical polymeric monomer or a cation polymeric monomer or both polymeric monomers may be simultaneously used, and to be more precise, compounds containing a polymerization group such as an epoxy group and an ethylene unsaturated group can be used. A polymeric monomer containing one or more of these polymerization groups in a molecule is used, and when containing two or more of these polymerization groups in the molecule, they may be different or same.

As the sensitizing dye is used one having an absorption peak in a wavelength of recording light, and a light absorption efficiency of the dye itself is preferably low in the wavelength of the recording light. As the sensitizing dye can be used known organic dyes such as a cyan, merocyan, phthalocyan, azo, azomethine, indoaniline, xanthene, coumarin, polymethine, diarylethene, fulgide fluorane, anthraquinone, and styryl. Further, as the other sensitizing dyes, a complex dye may be used. Among the polymerizing initiator are a radical precursor, a cation generator, and an acid generator and the like. As examples of the binder can be cited chlorinated polyethylene, polymethylmethacrylate, a copolymer of methylmethacrylate and (meta) acrylate alkylester other than methylmethacrylate, a copolymer of vinyl chloride and acrylonitrile, polyvinyl acetate, polyvinyl alcohol, polyvinyl methylal, polyvinyl butyral, polyvinyl pyrrolidone, ethylcellulose, accetylcellulose, and polycarbonate. It is preferable that the binder has a large difference in refractivity from that of the polymeric monomer. However, in a combination providing a too much difference, a mutually solubility between the binder and the polymeric monomer decreases, which may increase light scattering. Accordingly a binder having an appropriate refractivity is preferable. The photoreactive resin composition may, if necessary, appropriately contain something regularly used for forming an optical information recording layer of this kind of optical recording medium, such as a sensitizer, an optical brightening agent, an ultraviolet ray absorbing agent, a thermal stabilizer, a chain transfer agent, an elasticizer, and a coloring agent.

Further, other materials useable for a known optical recording medium in which the optical information is recorded by hologram can be used for the material of the optical information recording layer 12.

As other materials can be used a silver halide, a gelatin bichromate, a photorefractive material, a photochromic material, and the like. Further, as the material of the optical information recording layer 12, for example, a material for causing a change in refractive index accompanied with coloring and decoloring the dye. The materials of the optical information recording layer 12 can be used in an appropriate combination including, for example, a material including a dye colored or decolored by irradiation of the light on the photopolymer material or a photorefractive material in the optical reactive resin composition.

In addition, the optical information recording layer 12 may be made of a heat polymeric resin composition (heat hardening resin composition) in place of the photoreactive resin composition depending on the method of recording.

The above-mentioned optical recording medium OM can be obtained by a producing method including a process for forming the optical information recording layer 12 on the second light transmissive substrate 10b and a process for providing on the optical information recording layer 12 the first light transmissive substrate 10a in which the pits 11 are formed. Further, the optical recording medium OM can be also obtained by a producing method including a process for forming the information recording layer 12 on the light transmissive substrate 10a in which the pits 11 are formed. In addition, the pits 11 may be formed after formation of the optical Recording medium OM.

As a method of forming the pits 11 in the first light transmissive substrate 10a, for example, a method of molding, a drawing method including a laser-beam direct drawing method and an electron beam lithography, and a photographic method are listed.

The optical information recording layer 12 can be formed by, for example, coating the photoactive resin composition on the second light transmissive substrate 10b. In addition, the optical information recording layer 12 may be formed by polymerizing by heat or radicals using an injection molding method or may be formed by thermo-compression bonding and the like.

Next, will be described a method of recording the optical information in such an optical recording medium OM with reference to drawings. FIGS. 2A and 2B are schematically illustrating the process for recording the optical information in the optical recording medium.

First, the optical recording medium OM is attached to the driving shaft (not shown) of a well-known recording and reproducing apparatus with the center hole H (see FIG. 1A). While the optical recording medium OM is rotated about the driving shaft, as shown in FIG. 2A, the optical sensor 15 on the side of the recording and reproducing apparatus side detects the pits 11 formed in the periphery 14 of the optical recording medium OM. In this embodiment, the driving shaft is stopped to stop rotation of the optical recording medium OM at a location where the optical sensor 15 detects the pit 11 located at a reference location (hereinafter the pit 11 is referred to as “reference pit 11a” to differentiate it from other pits 11) out of a plurality of the pits 11. In this embodiment, the reference pit 11a is discriminated from other pits 11 by making the reflective of the pit 11a different from that of the pits 11 or by changing a pitch P between the neighboring pits 11 from the pitch P between the pits 11.

Next, the reference light and the recording light are applied to the optical recording medium OM, as well known, to multiple-record the optical information in the optical recording medium OM. In this event, as shown in FIG. 2A, the rotated optical recording medium OM is stopped when the optical sensor 15 detects the reference bit 11a, which positions a first recording location 16a to be irradiated by the recording light and the reference light (indicated as light beams R in FIG. 2A). The multiple recording method of the embodiment is known as an angular multiple recording method, wherein an incident angle of the reference light is changed for each beam of recording light of each optical information.

More specifically, the reference light having a predetermined incident angle is mixed with the first optical information light as well as the recording light and the reference light are applied to the first recording location 16a on the optical recording medium OM to form an interference pattern in the optical information recording layer 12 (see FIG. 1A). For example, if the photopolymer material is used, at a bright part of the interference pattern, the polymeric monomer is polymerized, and at a shade part of the interference pattern, the polymeric monomer moves to the bright part as well as the binder pushed by the polymeric monomer gathers. Then, the bright part of the interference pattern becomes polymer-rich as a result of polymerization of the polymeric monomer, and the shade part becomes binder-rich. Accordingly, the optical information is recorded in the optical information recording layer 12 as the interference pattern appearing as a difference in refractive index or light transmittance. Next, the incident light of the reference light is changed, and the reference light is mixed with recording light of second optical information. Then, an interference pattern is formed at the first recording location 16a (see FIG. 2A) where the first optical information has been recorded to record the second optical information in a superimposing manner. After that, the reference light is made have a different incident angle for the recording light for each piece of optical information of multiple recording and is mixed with the recording light to record a plurality of pieces of optical information at the recording location 16a of the optical information recording layer 12.

After termination of such multiple recording of the optical information at the first recording location 16a, the optical recording medium OM rotates about the driving shaft again. The optical sensor 15 monitors the light from the pit 11 to detect the pit 11. Next, the rotating optical recording medium OM is stopped when the optical sensor 15 detects the pit 11 next to the reference pit 11a to position, as shown in FIG. 2B, a second recording location 16b to be irradiated with the light beams R including the recording light and the reference light. The optical sensor 15 compares the detected light with a threshold value to detect the pit 11. In this case, the optical sensor 15 detects the pit 11 during rotation or stop of the optical recording medium OM. In addition, the optical sensor 15 may detect the change in a level of the detected light to detect the pit 11.

Here, the first recording location 16a and the second recording location 16b are allowed, whether or not an area of the first recording location 16a is overlapped with that of the second recording location 16b. The recording light and reference light at the second location 16b are recorded to multiple-record a plurality of pieces of optical information just as the multiple-recording is done at the first recording location 16a. After termination of the multiple recording at the second recording location 16b, the optical recording medium OM is rotated about the driving shaft as well as an irradiation location of the recording light and the reference light is determined by detecting the next pit 11 by the optical sensor 15.

In other words, in this embodiment, the optical information is recorded by the stop and go method in which the recording location 16 of the multiple recording (hereinafter referred to as “recording area”) is changed stepwise. After termination of recording the optical information in the optical recording medium OM, the polymeric monomer not used for recording the optical information is fixed by being exposed to laser light or light from a white light source or by a heat treatment.

On the other hand, the optical information recorded in the optical information recording layer 12 can be reproduced by irradiation of the reference light on each of the recording locations 16 including the first and second locations 16a and 16b. In this event, positioning each of recording locations 16 with respect to the reference light is performed by detecting the reference pit 11a and other pits 11 with the optical sensor 15 just as the optical information was recorded. Further, each of a plurality of pieces of the optical information multiple-recorded at each of the recording locations 16 is reproduced by irradiation of the reference light having the incident angle equal to that when the corresponding piece of the optical information is recorded.

In the above-described optical recording medium OM, the recording locations 16 are positioned with respect to the recording light and the reference light using the pits 11, which provides accurate optical recording and reproducing.

According to the optical recording medium OM, the recording region other than the periphery 14 is secured, which provides a high recording capacity of the optical information.

Further, according to the optical recording medium OM, the recording region of the optical information and the formation region of the pits 11 (positioning signal recording region) are separately provided, which prevents the recording light and the reference light from hitting to the pits 11, which may result in scattering. As a result, the optical recording medium OM can provide accurate recording and reproducing the optical information.

In addition, in the optical recording medium OM, the pitch P between pits 11 that determines an interval of the recording locations 16 neighboring and of which areas may be partially overlapped is made equal to or greater than 0.5 μm and not greater than 100 μm, which permits increase in the recording capacity of the optical information as well as provides accurate recording and reproducing of the optical information.

As mentioned above, the embodiment of the present invention has been described. The present invention is not limited to this embodiment, but can be modified. For example, in the above-mentioned embodiment, the pits 11 are provided by a local change in a physical property of the medium forming material of the optical recording medium OM, as compared with its vicinity. Here, the physical property change may be a local change in physical characteristic in the medium forming material such as a local change in refractive index of light, the transmittance, an amount of reflection light with respect to the irradiation light, a wavelength of the reflection light with respect to the irradiation light, or a light scattering degree, as compared with its vicinity.

The pit 11 can be replaced with a protrusion, a hole, a protruding rail, a channel, a ridge and channel pattern provided by combining these with air gap (bubbles) and the like.

In addition, in the embodiment, the pits 11 are formed at an outside surface of the light transmissive substrate 10a (opposite to the optical recording layer 12). However, in the present invention, the pits 11 may be formed in an inside surface of the light transmissive substrate 10a (on the side of the optical recording layer 12). Further, the pits 11 may be formed at both outside and inside of the light transmissive substrate 10a. Furthermore, in the embodiment, a plurality of the pits 11 are formed at the periphery 14. However, only one pit 11 may be formed at the periphery 14. Further, the pits 11 are formed in a plurality of lines.

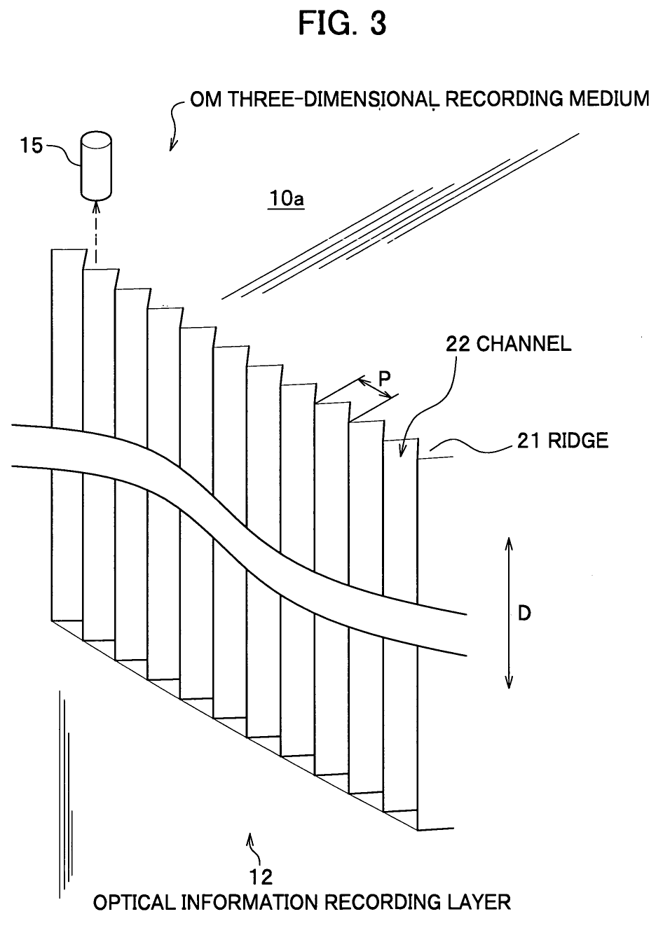

In addition, the local change in the medium forming material may be formed in a side surface of the optical recording medium OM extending in a thickness direction along circumference thereof. For example, this type of the optical recording medium OM is shown in FIG. 3, which includes ridge 21 and channels 22 extending in a thickness direction D of the optical recording medium OM and arranged on a circumferential surface of the first light transmissive substrate 10a. The ridge 21 and the channels 22 are arranged alternately with a predetermined pitch P on the circumferential surface of the first light transmissive substrate 10a. In this optical recording medium OM, the recording areas 16 are positioned with respect to the recording light and the reference light by detecting the ridges 21 or the channel 22 with the optical sensor 15.

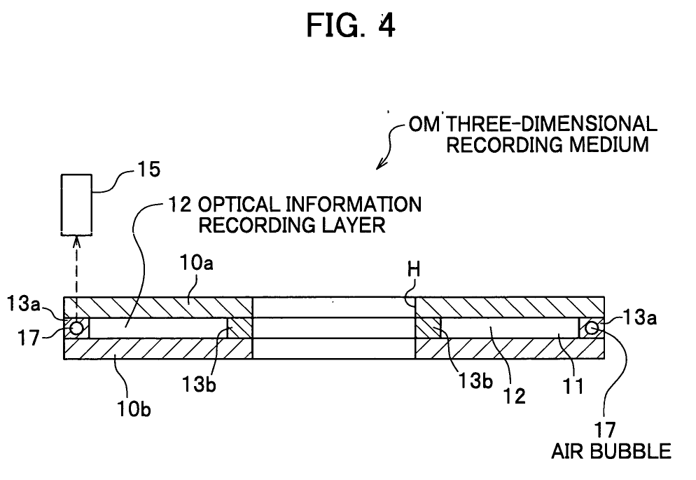

In the above-described embodiment, the local change (the pit 11) of the medium forming material is provided in the first light transmissive substrate 10a. However, the change of the medium forming material may be provided in a part other than the first light transmissive substrate 10a. For example, FIG. 4 shows such an optical recording medium OM, wherein the change in the medium forming material is provided at a light-transmissive spacer 13a arranged between the light-transmissive substrates 10a and 10b. FIG. 4 shows a schematic cross-section in a thickness direction of the optical recording medium OM.

In the optical recording medium OM, as shown in FIG. 4, the optical information recording layer 12 is formed at a part defined between the light transmissive substrates 10a and 10b and between an outside spacer 13a, having a ring shape, arranged along a circumference thereof and an inside spacer 13g, having a ring shape, arranged along a circumference of a hole corresponding to the center hole H. In this optical recording medium OM, the change in the medium forming material is provided in the outside spacer 13a as air bubbles 17. In the optical recording medium OM, the recording light and the reference light are positioned by detecting the bubbles 17 with the optical sensor 15.

In addition, in this embodiment, the three-dimension recording medium for recording optical information using the holography (interference pattern) has been described. However, this invention is not limited to this, but allows the optical information recording layer to be formed using a two-photon absorption material. As the two-photon absorption material, are available a material consists of a first compound in which some chemical and/or physical change occurs in itself upon two-photon or multi-photon absorption, a material made of a two-photon or multi-photon absorption compound and a second compound in which some chemical and/or physical change is induced by the two-photon or multi-photon absorption, and a material made of a third compound having a function for adjusting these recording mechanisms in addition to the two-photon or multi-photon absorption compound and a second compound. For example, the two-photon absorption material is disclosed in Japanese laid-open patent application publication No. 2002-172864.

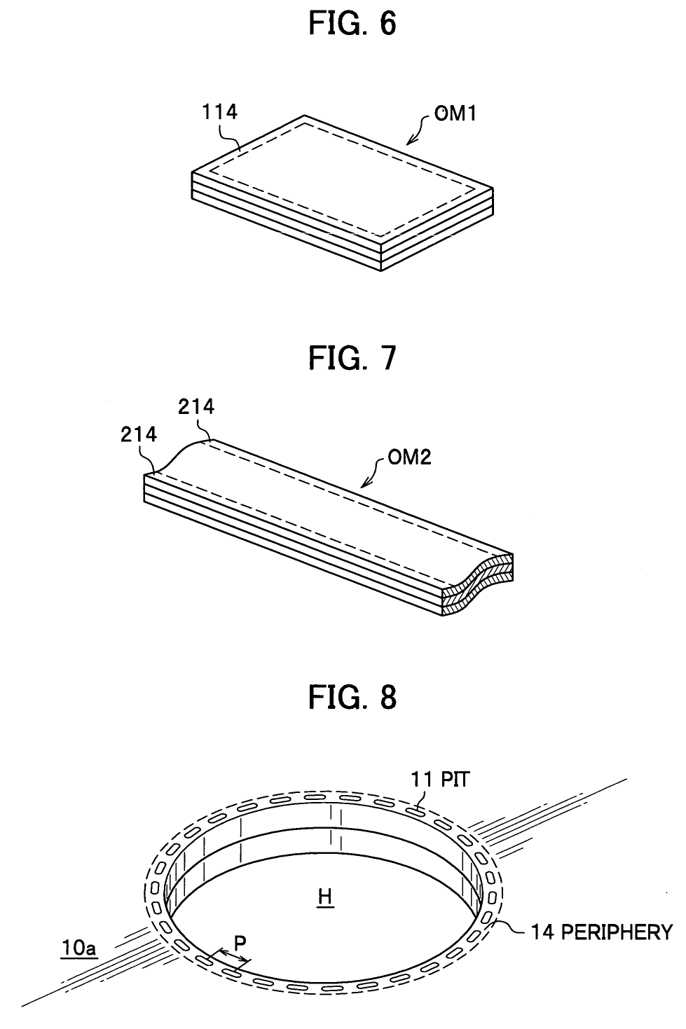

In this embodiment, the disk-like optical recording medium OM has been described. However, the present invention is not limited to this, but an optical recording medium OM1 may be formed in a card as shown in FIG. 6. Further, the optical recording medium OM1 may be formed in a tape as shown in FIG. 7. The periphery 114 of the optical recording medium OM1 is provided for recording the positioning signal. An optical recording medium OM2 may be formed in a tape as shown in FIG. 7. The periphery 214 of the optical recording medium OM2 is provided for recording the positioning signal.

Further, in the optical recording medium OM, a periphery 14 may be provided around the center hole H as shown in FIG. 8.

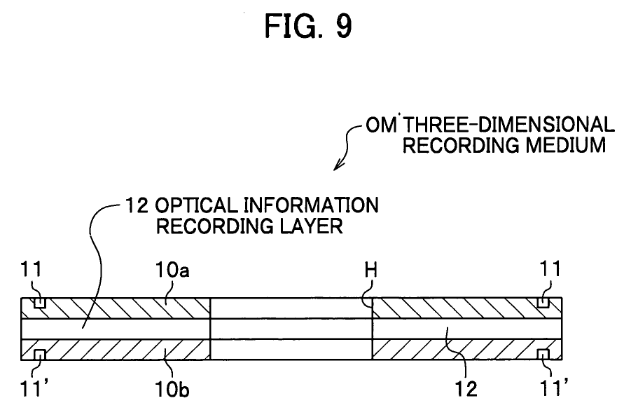

Further, the positioning signal is, as shown in FIG. 9, provided both at the first and second light transmissive substrates 10a and 10b. The positioning signal is recorded by an optically detectable local change in a physical property of the optical recording medium, a type of the change recorded in the first light transmissive substrate 10a is the same as or different from a type of the change recorded in the second light transmissive substrate 10b.

In the above-described embodiment, the optical recording medium OM for recording the optical information by the angular multiplex recording method is disclosed. However, the present invention is not limited to this, but an optical recording medium for recording the optical information by a shift multiplex method, a wavelength multiplex method, a phase code multiplex method, or a polytopic multiplex method in place of the multiplex recording method.

The shift multiplex method is disclosed in U.S. Pat. No. 5,671,073, which is incorporated herein by reference. The wavelength multiplex hologram is disclosed in U.S. Pat. No. 6,023,355, which is incorporated herein by reference. The phase code multiplex method is disclosed in U.S. Pat. No. 6,961,161, which is incorporated herein by reference. The polytopic multiplex method is disclosed in U.S. Patent Application No. 20040179251, which is incorporated herein by reference. In addition, an optical recording medium for recording the optical information by a multiplexing method derived by combining the angular multiplex recording method and other above-described methods.

In FIG. 3, the physical property change is provided on the side surface extending in the thickness direction D, of the optical recording medium OM, and the physical property change includes the ridges 21 and channels 22, extending in the thickness direction D to a surface of the optical recording medium OM, alternately arranged on the side surface at a predetermined pitch to provide a zigzag pattern at the surface of the optical recording medium OM.

### EXAMPLE

Here will be concretely described the present invention according to examples of the invention. However, the present invention is not limited to this embodiment.

### Example 1

<Production of Optical Recording Medium>

In an Example 1, the optical recording medium OM as shown in FIG. 1 is produced. First, a photoactive resin composition is prepared by dispensing and mixing a binder, a monomer, polymerization inhibitors, a sensitizing dye, and a polymerization initiator, and dichloromethane as a solvent to have mass ratios shown in Table 1.

TABLE 1

| | | Mass |
|---|---|---|
| | Material | Ratio |
| Binder | CAB531-1 | 1000 |
| Monomer | POEA | 920 |
| Polymerisation | MEHQ | 0.276 |
| Inhibitor | | |
| Sensitizing | DEAW | 0.56 |
| Dye | | |
| Polymerisation | MBO | 36 |
| Initiator | o-CL-HABI | 24 |
| Solvent | Dichloromethane | 6240 |

NB:
CAB531-1, Cellulose-Acetate-Butylate (manufactured by Eastman Chemical Co.);
POEA, Acrylic Acid 2-Phenoxyetyl (Cas No. 48145-04-6);
MEHQ, 4-Methoxyphenol (Cas No. 150-76-5);
DEAW, Cyclopentanone-2,5-bis((4-(Diethyl Amino)Phenyl)Methylene) (Cas No. 38394-53-5);
MBO, 2-Melcaptobenzoxazole (Cas No. 2382-96-9); and
o-CL-HABI, 2,2-bis(o-Chlorophenyl)-4,4,5,5-Tetoraphenyl-1,1-Biimidazole (Cas No. 1707-68-2).

The mixing was done under a red lamp, wherein respective materials were put in a brown eggplant-shape flask, and they were stirred for three hours, using a stirrer. The obtained photoactive resin composition (hereinafter, referred to as “resin composition A”) had a viscosity of 21 Pas.

The resin composition A was coated on a light transmissive substrate 10b (polycarbonate, thickness 80 μm) with using a coater of a clearance of 300 μm (gap length), and was dried for three minutes at 40° C. Furthermore, subsequently, a process of coating and drying the resin composition A at 40° C. for three minutes was repeated twice. Thus, an optical information recording layer 12 was formed on the second light transmissive substrate 10b.

Next, the second light transmissive substrate 10b having the optical recording layer 12 is stamped to have a disk with a diameter of 12 cm. On the other hand, the first light transmissive substrate 10a of a glass substrate (thickness, 1 mm) with a diameter of 12 cm was prepared. Further, a plurality of pits 11 (see FIG. 1B) are formed in the first light transmissive substrate 10a along a circumference thereof. The pits 11 are formed by irradiating an electron beam onto a surface of the first light transmissive substrate.

Next, the first light transmissive substrate 10a is adhered to the optical information recording layer 12 to produce the optical recording medium OM. In this process, a side of the first light transmissive substrate 10a where no pit 11 is formed is adhered to the optical information recording layer 12. In addition, a thickness of the optical information recording layer 12 of the optical recording medium OM is measured.

The optical information recording layer 12 was measured in thickness, using DIGITAL MICROMETER manufactured by SONY CO. The thickness of the optical information recording layer 12 was calculated by subtracting a thickness of the first light transmissive substrate 10a and the second light transmissive substrate 10b from a measured total thickness of the optical recording medium OM. The thickness of the optical information layer 12 is shown in Table 2.

TABLE 2

| | | | Comparison | Comparison |
|---|---|---|---|---|
| | Example 1 | Example 2 | Example 1 | Example 2 |
| Resin | A | B | A | B |
| Compound | | | | |
| Thickness of | 120 | 120 | 120 | 122 |
| Optical | | | | |
| Information | | | | |
| Layer (μm) | | | | |
| Diffraction | 70 | 71 | 65 | 70 |
| Efficiency on | | | | |
| Recording (%) | | | | |
| Diffraction | 68 | 70.2 | 62 | 63 |
| Efficiency on | | | | |
| Reproducing | | | | |
| (%) | | | | |
| Pit | Only Edge | Only Edge | Entire | No Pit |
| Arrangement | | | Surface | |

<Measurement of Diffraction Efficiency of Optical Recording Medium>

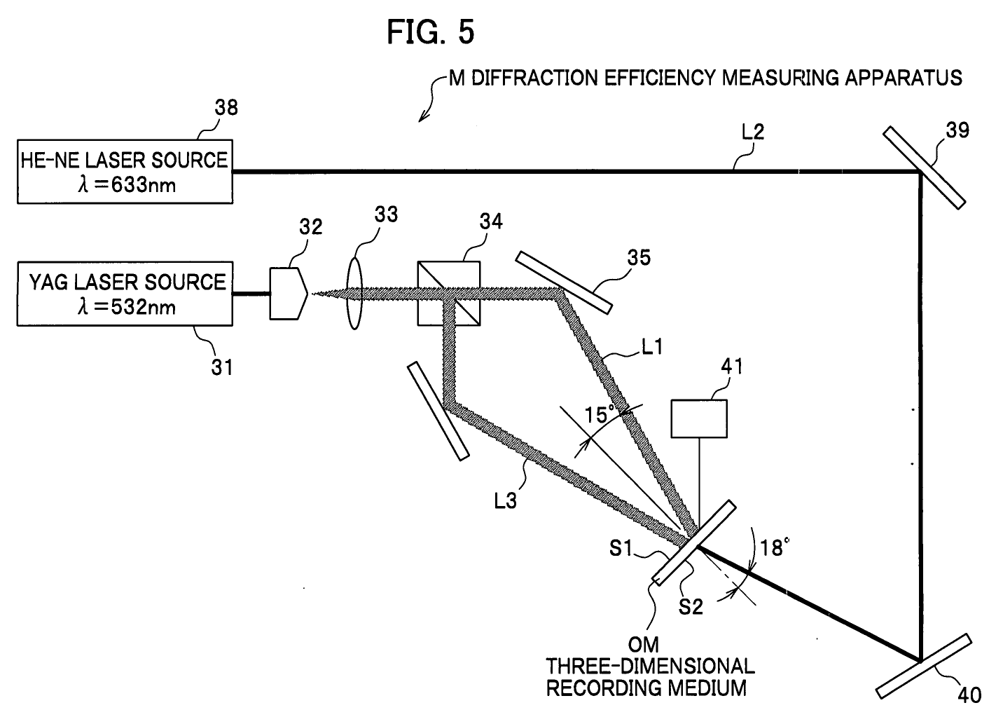

The produced optical recording medium OM was used for recording and reproducing the optical information. The diffraction efficiency upon recording and reproducing was measured by a diffraction efficiency measuring apparatus M shown in FIG. 5.

When the optical information is recorded on and reproduced from the optical recording medium OM, as shown in FIG. 2A, the peripheral 14 is irradiated with a red laser light, and the reflected light is detected by the optical sensor 15. The laser light source (not shown) may be arranged in the same housing (not shown) of the optical sensor 15. Further, the laser light source (not shown) may be arranged at a side of the optical sensor 15 and the red laser light may be reflected to be directed to the peripheral 14 with a diagonal half mirror (not shown) to have the same optical axis of the reflected laser light to the optical sensor 15. In addition, the optical sensor 15 may be slightly inclined to receive the laser light reflected from the peripheral 14 irradiated by the laser light source (not shown) slightly remote from the optical sensor 15.

The position of the pit 11 is detected by a local change in a reflectance of the read laser light to position an area inside (the center side of the optical recording medium OM) the pit 11 at a distance of 1 cm so as to be irradiated with the recording light and the reference light.

As shown in FIG. 5, YAG laser light (a wavelength of 532 nm) radiated from a YAG laser source 31 through an object lens 32, a lens 33, a beam slitter 34, a mirror 35, and a spatial modulation element (not shown) is irradiated on a surface S1 of the optical recording medium OM. In this event, an incident angle of the recording light L1 to a surface S1 of the optical recording medium OM is set to 15 degrees, and a diameter of the spot is set to 8 mm. Further, the light spitted by a beam splitter 34 is mixed with the reference beam L1 transmitted through the mirror 35.

As a result, the optical information is recorded by forming the interference pattern in the optical recording medium OM (optical recording layer 12). Further, in this diffraction efficiency measuring apparatus M, schedule recording was done to obtain the same diffraction efficiency as that upon the multiplex recording on the optical recording medium OM.

Upon recording the optical information, He—Ne laser light L2 having a wavelength of 633 nm was applied to a reverse surface S2 of the optical recording medium OM at an incident angle of about 18 degrees (Bregg angle) from a He—Ne laser source 38 through mirrors 39 and 40. A change in the diffraction efficiency was observed for an exposure amount at this time.

The diffraction efficiency is obtained according to Equation (1) from a diffraction light amount of the He—Ne laser measured by a power meter 41 provided at a side of the surface S1 of the optical recording medium OM and an incident light amount (outgoing light amount from the He—Ne laser source 38).
Diffraction efficiency(%)=intensity of diffraction light/intensity of incident light×100 (1)
The resultant diffraction efficiency (%) upon recording is also shown in the Table 2.

Next, the optical information is reproduced by irradiating the reference light L3 on the optical recording medium OM. In this embodiment, positioning the reference light L3 at the irradiation location is performed by detecting the pit 11 in the same manner as recording the optical information. Further, the diffraction efficiency (%) upon reproducing is obtained by irradiating the He—Ne laser light L2 on the rear face S2 of the optical recording medium OM in the same manner as the diffraction efficiency (%) is measured upon recording. The result is also shown in Table 2.

### Example 2

A resin compound B is used in place of the resin compound A used in the example 1, and the optical recording medium is produced in the same manner as the first example. The resin compound B is prepared by dispensing and mixing the binder, a dye decolored by an acid, an acid generator, a sensitizing dye, and methylene chloride and acetonitrile as a solvent to have mass ratios shown in Table 3.

TABLE 3

| | | Mass |
|---|---|---|
| | Material | Ratio |
| Binder | PMMA | 1000 |
| Dye | Dye A | 80 |
| decolored by | | |
| acid | | |
| Acid | Acid | 500 |
| Generator | Generation | |
| | Agent A | |
| Sensitizing | Dye B | 80 |
| Dye | | |
| Solvent | Methylene | 3250 |
| | Chloride | |
| Solvent | Acetonitrile | 1052.5 |

NB:
PMMA is Polymethylmethacrylate (manufactured by Aldrich Inc. Mw: 996000); Dye A, a quaternary ammonium salt expressed in a formula (a) below;

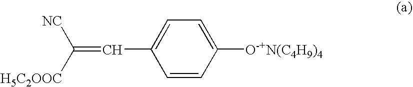

Acid Generation Agent A is Diphenyliodonium-Hexafluorophosphate (Cas No. 58109-40-3); and Dye B, Ru complex compound expressed in a formula (b) below.

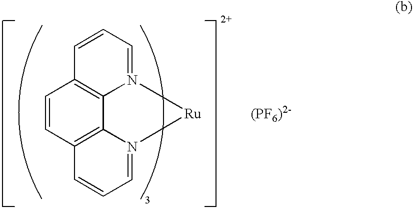

The diffraction efficiency (%) of the obtained optical recording medium is obtained in the similar manner to the first embodiment.

<Comparison 1>

In Example 1, except that the pits 11 are formed over a surface of the second light transmissive substrate, the optical recording medium is produced in the same manner as the first example, and the diffraction efficiency (%) of the obtained optical recording medium is obtained. Table 2 also shows this result.

<Comparison 2>

In Example 2, except that no pit 11 is formed in the second light transmissive substrate 10b, the optical recording medium is produced in the same manner as the second example, and the diffraction efficiency (%) of the obtained optical recording medium is obtained. Table 2 also shows this result.

<Evaluation of Diffraction Efficiency>

As clearly shown in Table 2, the optical recording mediums OM of Examples 1 and 2 show preferable diffraction efficiency both upon recording and reproducing the optical information.

On the other hand, the optical recording medium of the Comparison 1 has diffraction efficiency upon recording which is low. This is because in the optical recording medium of Comparison 1 the pits 11 are formed over the entire surface of the first light transmissive substrate 10a, so that the recording light L1 and the reference light L3 hit the pits are scattered. Further, the optical recording medium of Comparison 2 shows a low diffraction efficiency upon reproducing. This is considered that, in the optical recording medium of Comparison 2, no pit 11 is formed, so that the irradiation location of the reference light L3 is inaccurately positioned at a recording location of the optical information.

As mentioned above, the recording region only at the periphery 14 of the optical recording medium OM, records the positioning signal as the pit 11 to determine the recording location 16 of each local recording cycle of the optical information.

The invention claimed is:

1. A three-dimensional optical recording medium comprising:
first and second light transmissive substrates;
an optical information recording layer held and sandwiched between the first and second light transmissive substrates for recording optical information; and
a recording region only at a periphery of the optical recording medium, the recording region recording a positioning signal to determine a recording location of the optical information.

2. The three-dimensional optical recording medium as claimed in claim 1, wherein the positioning signal is recorded by a local physical property change of the optical recording medium which is optically detectable.

3. The three-dimensional optical recording medium as claimed in claim 2, wherein the physical property change includes a local shape of the optical recording medium different from the vicinity of the local shape of the optical recording medium.

4. The three-dimensional optical recording medium as claimed in claim 3, wherein the local shape is selected from a group consisting of a pit, a hole, an air gap, a ridge, a channel, and a pattern including the ridges and channels.

5. The three-dimensional optical recording medium as claimed in claim 2, wherein the physical property change includes a characteristic change of the optical recording medium different from vicinity of the physical property change of the optical recording medium.

6. The three-dimensional optical recording medium as claimed in claim 5, wherein the characteristic change is selected from the group consisting of an optical diffraction change, an optical transmittance change, a reflectance change regarding an illumination light, and a wavelength change regarding an illumination light.

7. The three-dimensional optical recording medium as claimed in claim 5, wherein the characteristic change is provided at a surface of the optical recording medium.

8. The three-dimensional optical recording medium as claimed in claim 2, wherein the physical property change is provided inside the optical recording medium.

9. The three-dimensional optical recording medium as claimed in claim 2, wherein the physical property change is periodically provided at a surface of the optical recording medium at an interval not less than 0.5 μm and not greater than 100 μm.

10. The three-dimensional optical recording medium as claimed in claim 2, wherein the physical property change is provided on a side face extending in a thickness direction of the optical recording medium, and the physical property change includes ridges and channels, extending in the thickness direction to a surface of the optical recording medium, alternately arranged on the side face at a predetermined pitch to provide a zigzag pattern at the surface of the optical recording medium.

11. The three-dimensional optical recording medium as claimed in claim 1, wherein the positioning signal is provided both at the first and second light transmissive substrates.

12. The three-dimensional optical recording medium as claimed in claim 11, wherein a type of the physical property change recorded in the first light transmissive substrate as the positioning signal is the same as a type of the physical property change recorded in the second light transmissive substrate as the positioning signal.

13. The three-dimensional optical recording medium as claimed in claim 11, wherein a type of the change recorded for the positioning signal in the first light transmissive substrate as the positioning signal is different from a type of the change recorded for the positional signal in the second light transmissive substrate as the positioning signal.

14. The three-dimensional optical recording medium as claimed in claim 1, wherein the first and second light transmissive substrates and the optical information recording layer are each formed in a disk to provide a disk of the optical recording medium.

15. The three-dimensional optical recording medium as claimed in claim 14, wherein the recording region is provided at a periphery of the disk of the optical recording medium.

16. The three-dimensional optical recording medium as claimed in claim 14, wherein the disk of the optical recording medium includes a center hole, and the recording region is provided around the center hole.

17. The three-dimensional optical recording medium as claimed in claim 1, wherein the first and second light transmissive substrates and the optical information recording layer are each in a form selected from the group consisting of a disk, a card, and a tape.

18. The three-dimensional optical recording medium as claimed in claim 1, wherein the optical information is recorded by at least a method selected from the group of a shift multiplexing method, an angular multiplexing method, a wavelength multiplexing method, a phase code multiplexing method, and a Polytopic multiplexing method.

19. The three-dimensional optical recording medium as claimed in claim 1, wherein the optical information is recorded by a stop and go method.

20. The three-dimensional optical recording medium as claimed in claim 1, wherein the three-dimensional optical information recording layer extending in a plane, and the positioning signal is recorded at only the periphery of the optical recording medium with respect to the plane.
